(19) United States
(12) Patent Application Publication
(10) Pub. No.: US 2014/0265157 A1
(43) Pub. Date: Sep. 18, 2014

(54) SUMP WALL PENETRATION FITTING FOR FLEXIBLE PIPING

(71) Applicant: S. BRAVO SYSTEMS, INC., Commerce, CA (US)

(72) Inventors: Don K. Mukai, Pasadena, CA (US); Micah J. Nelson, Yuba City, CA (US); Juan S. Albino, Baldwin Park, CA (US)

(73) Assignee: S. BRAVO SYSTEMS, INC., Commerce, CA (US)

(21) Appl. No.: 13/827,013

(22) Filed: Mar. 14, 2013

(51) Int. Cl. F16J 15/02

(52) U.S. Cl. CPC F16J 15/022
USPC 277/606

(57) ABSTRACT

A penetration fitting configured to form a seal around a flexible pipe penetrating through an aperture in a sump wall is provided. In one embodiment, the penetration fitting includes first and second fitting halves defining first and second arcuate channels having a wider end and a narrower end, wherein the first and second fitting halves are configured to abut one another with the arcuate channels of the first and second fitting halves together defining a tapered opening, the tapered opening having a smaller diameter at an inner end and a larger diameter at an outer end with the inner end configured to be sealed to the sump wall around the aperture, an elastically deformable sealing ring configured to be received in the tapered opening, the sealing ring defining an opening configured to accept the flexible pipe, and a compression plate configured to retain the sealing ring in the tapered opening.

### FIELD OF THE INVENTION

The present invention relates generally to penetration fittings, and more particularly to penetration fittings configured to seal one or more flexible pipes penetrating a sump wall.

### BACKGROUND

Underground storage tank (UST) fueling sites, such as retail gas stations, include pipelines carrying a product such as gasoline from the storage tank to a product dispenser. Each pipeline typically includes a primary pipeline through which the product flows, and a secondary pipeline that surrounds the primary pipeline. The purpose of the secondary pipeline is to contain any fluid that may leak from a damaged primary pipeline, and prevent the fluid from contaminating the surrounding ground. As used herein, the primary pipeline and the secondary pipeline are referred collectively as the pipeline or the pipe.

A sump is also typically provided beneath the product dispenser to contain any fuel released from failed equipment and thereby prevent environmental contamination (e.g., ground water contamination) under and around the service station. Each of the primary pipelines extends through an aperture in the wall of the sump to a pipe fitting which connects the primary pipeline to the product dispenser. The aperture in the sump wall through which the pipeline penetrates must be sealed to prevent the accumulated fuel in the sump from leaking through the aperture in the sump wall and into the surrounding ground. Accordingly, penetration fittings are provided to form seals between the sumps and the associated pipelines to contain fuel leakage within the sumps.

Flexible piping is commonly used to facilitate ease of installation of the piping between the UST and the product dispenser. Flexible piping generally includes a thicker-walled primary pipe for carrying the fuel to from the UST to the dispenser and a thin-walled secondary jacket co-axial with the primary pipe. Flexible piping is commonly constructed of flexible materials such as polyethylene, polyvinylidene fluoride (PVDF), or Nylon 12. However, flexible piping is prone to swelling in the sump environment (also referred to as “pipe growth”) because some plastics absorb hydrocarbons, which causes the piping to swell and elongate.

Conventionally, flexible boots are used to seal between the pipeline and the sump because flexible boots can bend to accommodate “pipe growth” in the pipelines. However, conventional flexible boots are made of materials having a relatively low chemical resistance (e.g., rubber or plastic) that degrade quickly and prematurely fail in the harsh sump environment. When these conventional flexible boots fail and begin to leak, they are conventionally replaced with a split repair boot or fitting. However, these split repair boots are also conventionally made from a material having a relatively low chemical resistance (e.g., urethane based plastic) that tends to degrade and fail quickly in the sump environment. Additionally, because flexible boots must bend to accommodate pipes penetrating the sump wall at an oblique angle, the flexible boots are under constant stress which can lead to premature failure.

Other conventional penetration fittings may be made of a rigid material, such as hard plastic. However, such conventional rigid fittings must be installed during construction of the UST fueling site and the installation of the sumps. Installing these conventional fittings to retrofit an existing sump installation, rather than during construction of the fueling site, requires excavation of the surrounding soil, cutting the pipeline, and sliding the penetration fitting over the cut end of the pipeline. Accordingly, retrofitting an existing sump installation with these conventional rigid penetration fittings may be both cost and time prohibitive. Moreover, these rigid conventional fittings are commonly made from a material having a low chemical resistivity, and therefore these rigid fittings have a short service life in a sump environment. Additionally, these conventional rigid fittings cannot accommodate pipes which penetrate the sump wall at an oblique angle.

Other conventional penetration fitting may use tapered wedges to accommodate pipes penetrating the sump at an oblique angle. However, such tapered wedges increase the overall profile or envelope of the fitting. The increased profile of the fitting may make the fitting unsuitable for use with certain sump and pipe configurations.

### SUMMARY

The present invention relates generally to penetration fittings, and more particularly to penetration fittings configured to seal one or more flexible pipes penetrating a sump wall.

According to embodiments of the invention, the penetration fitting may be configured to accommodate flexible pipes which tend to suffer “pipe growth” due to the presence of hydrocarbons in the sump. The penetration fitting may also be configured to retrofit a failed penetration fitting without having to excavate the site and cut the pipeline. These penetration fittings may also be constructed of a durable material having a relatively high chemical resistance to hydrocarbons.

In one embodiment, the penetration fitting includes a first fitting half having an inner surface and an outer surface opposite the inner surface, the first fitting half defining a first arcuate channel having a wider end and a narrower end. The penetration fitting also includes a second fitting half having an inner surface and an outer surface opposite the inner surface, the second fitting half defining a second arcuate channel having a wider end and a narrower end. The first and second fitting halves are configured to abut one another with the inner surfaces of the first and second fitting halves together defining an inner end, the outer surfaces of the first and second fitting halves together defining an outer end, and the arcuate channels of the first and second fitting halves together defining a tapered opening. The tapered opening includes a smaller diameter at the inner end and a larger diameter at the outer end, with the inner end configured to be sealed to the sump wall around the aperture. The tapered opening in the penetration fitting may be generally frusto-conical. The arcuate channels taper at an angle between approximately 5 degrees and approximately 50 degrees. The fitting halves may be made of fiberglass reinforced plastic (FRP). Additionally, the inner and outer ends of the fitting halves may be spaced apart by a distance between approximately 1 inch and approximately 2.5 inches.

The first fitting half may also include a semi-annular first flange formed about a periphery of the narrower end of the first arcuate channel, and the second fitting half may also include a semi-annular second flange formed about a periphery of the narrower end of the second arcuate channel. The first and second semi-annular flanges cooperate to define an annular flange on the inner end of the fitting configured to surround the aperture in the sump wall. In addition, the first fitting portion may also a semi-annular first lip formed about a periphery of the wider end of the first arcuate channel, and the second fitting portion may also include a semi-annular second lip formed about a periphery of the wider end of the second arcuate channel. The first and second semi-annular lips cooperate to define an annular lip on the outer end of the fitting. The diameter of the annular flange is larger than the diameter of the annular lip such that an annular shoulder defined between the annular flange and the annular lip. In one embodiment, the penetration fitting may include an annular band configured to surround the annular lip to bias the first and second fitting halves together at the shoulder.

The penetration fitting also includes an elastically deformable sealing ring configured to be received in the tapered opening defined by the fitting halves. The sealing ring includes an inner end and an outer end opposite the inner end. The inner end of the sealing ring is configured to abut an annular lip in the fitting halves, which is configured to retain the sealing ring in the tapered opening. The sealing ring defines an opening configured to accept the at least one flexible pipe segment. The sealing ring may both be generally frusto-conical. The sealing ring also includes a slit configured to enable the sealing ring to be wrapped around the pipe. Alternatively, the sealing ring includes first and second sealing ring halves attachable together around the at least one flexible pipe. The sealing ring may be made of rubber having a hardness between approximately 60 Shore A and approximately 70 Shore A.

The penetration fitting also includes a compression plate configured to retain the elastically deformable sealing ring in the tapered opening. The compression plate includes an inner surface configured to abut the outer end of the first and second fitting halves and the outer end of the sealing ring. The first and second fitting halves further include a plurality of circumferentially disposed openings and the compression plate further comprises a plurality of circumferentially disposed openings configured to align with the openings in the first and second fitting halves. The openings in the fitting halves and the compression plate are configured to receive a plurality of fasteners coupling the compression plate to the first and second fitting halves.

The penetration fitting may include an adapter plate configured to accommodate a sump wall with a curved inner wall surface. In one embodiment, the adapter plate includes an annulus having opposing inner and outer surfaces, and an opening extending between the inner and outer surfaces, wherein the inner surface is curved and the outer surface is substantially flat, and wherein the inner surface is configured to abut the curved inner wall surface of the sump wall, and the outer surface is configured to abut the inner end of the fitting halves, thereby permitting the inner end of the first and second fitting halves to be sealed to the sump wall via the adapter plate. The adapter plate includes a first adapter plate half and a second adapter plate half, the first and second adapter plate halves being attachable together around the at least one pipe.

The penetration fitting may include a hub configured to mechanically secure the penetration fitting to the sump wall and draw the sump wall flush against the hub. In one embodiment, the hub includes a first semi-annular rim, a second semi-annular rim attachable to the first semi-annular rim, the first and second semi-annular rims cooperating to define an opening, and a plurality of apertures disposed circumferentially around the rims, the plurality of apertures configured to receive a plurality of fasteners securing the hub to the sump wall, wherein the hub includes opposing inner and outer surfaces, the inner surface configured to abut an inner wall surface of the sump wall, and the outer surface configured to abut the inner end of the fitting halves, thereby permitting the inner end of the first and second fitting halves to be sealed to the sump wall via the hub. The first semi-annular rim further includes a first semi-annular standoff extending around a periphery of the first semi-annular rim, and the second semi-annular rim further includes a second semi-annular standoff extending around a periphery of the second semi-annular rim. Additionally, the first and second semi-annular rims each include at least one narrow ridge projecting from the inner surface and adapted to penetrate into the inner wall surface of the sump wall.

The penetration fitting may also include an adhesive layer disposed between an inner wall surface of the sump wall and the inner surfaces of the fitting halves. The penetration fitting may also include an adhesive layer disposed between the inner surface of the adapter plate and the inner wall surface of the sump wall and between outer surface of the adapter plate and the inner surfaces of the fitting halves. The penetration fitting may include an adhesive bead extending along a joint between the semi-annular standoffs and the inner surfaces of the fitting halves. The adhesive includes a resin, such as an epoxy-based, vinylester-based, or polyester-based resin, and a filler, such as fumed silica or fiberglass filler. In one embodiment, the adhesive has a viscosity between approximately 2,000 centipoise (cps) and 10,000,000 cps. The penetration fitting halves are generally rigid and may include fiberglass reinforced plastic (FRP).

This summary is provided to introduce a selection of concepts that are further described below in the detailed description. This summary is not intended to identify key or essential features of the claimed subject matter, nor is it intended to be used in limiting the scope of the claimed subject matter.

### BRIEF DESCRIPTION OF THE DRAWINGS

Embodiments of a sump wall penetration fitting according to the present invention are described with reference to the following figures. The same reference numerals are used throughout the figures to reference like features and components. The figures are not necessarily drawn to scale.

FIG. 1A is a rear perspective view of a penetration fitting having two fitting halves, an elastically deformable sealing ring, and a compression plate, according to an embodiment of the present invention forming a seal around a flexible pipe passing through an aperture in a sump wall;

FIG. 1B is an exploded rear perspective view of the penetration fitting of FIG. 1A;

FIG. 1C is an enlarged partial cross-sectional view of the penetration fitting, the flexible pipe, and the sump wall of FIG. 1A;

FIG. 1D is an enlarged partial cross-sectional view showing the flexible pipe passing through the sump wall and the penetration fitting of the present invention at an oblique angle;

FIGS. 2A and 2B are front and rear exploded perspective views, respectively, of the fitting halves of FIG. 1A;

FIGS. 3A and 3B are front and rear perspective views, respectively, of the elastically deformable sealing ring of FIG. 1A;

FIG. 4 is an exploded rear perspective view of the compression plate of FIG. 1A;

FIGS. 5A and 5B are a rear perspective view and an enlarged partial cross-sectional view, respectively, of an adapter plate according to an embodiment of the present invention disposed between a curved sump wall and the penetration fitting of FIG. 1A;

FIG. 5C is an exploded front perspective view of the adapter plate of FIGS. 5A and 5B;

FIG. 6A is a rear perspective view of a hub according to an embodiment of the present invention disposed between the sump wall and the penetration fitting of FIG. 1A;

FIG. 6B is a front perspective view of an existing boot forming a seal around the flexible pipe penetrating the sump wall;

FIG. 6C is an enlarged partial cross-sectional view of the penetration fitting and hub of FIG. 6A coupled to the boot of FIG. 6B; and

FIGS. 6D and 6E are exploded front and rear perspective views, respectively, of the hub of FIG. 6A.

### DETAILED DESCRIPTION

The present invention is directed to a penetration fitting configured to create a fluid-tight seal around one or more pipes passing through an aperture in a sump wall. The penetration fitting of the present invention is a split-type fitting configured to retrofit existing sump installations without having to excavate the soil around the sump or cut the pipe. The penetration fitting is configured to accommodate flexible pipes which tend to suffer “pipe growth” due to the presence of hydrocarbons in the sump (i.e., the penetration fitting is configured accommodate elongation of the pipe due to the absorption of hydrocarbons by allowing the pipe to “slip” relative to the penetration fitting). The penetration fitting is also configured to accommodate one or more pipes passing through the aperture at an oblique angle relative to the sump wall. Additionally, the penetration fitting is a rigid fitting having a high chemical resistivity to hydrocarbons.

In an embodiment of the present invention illustrated in FIGS. 1A-1C, a penetration fitting 100 is shown surrounding a pipe 101 (e.g., a flexible fluid pipeline carrying fuel between a storage tank and a product dispenser) penetrating an aperture 102 in a sump wall 103. The penetration fitting 100 is configured to surround the pipe 101 and abut an inner wall surface 104 of the sump wall 103 to create a fluid-tight seal between the pipe 101 and the aperture 102 in the sump wall 103. The penetration fitting 100 includes first and second fitting halves 105, 106, an elastically deformable sealing ring 107, and a compression plate 108 having first and second compression plate halves 109, 110. The first and second fitting halves 105, 106, the elastically deformable sealing ring 107, and the first and second compression plate halves 109, 110 are all configured to enable the fitting 100 to be installed around the existing pipe 101 without the need to cut and replace the pipe 101.

With continued reference to FIGS. 1A and 1B, the first and second fitting halves 105, 106 are configured to be attached together around the pipe 101. The first and second fitting halves 105, 106 include adjoining ends 111, 112 and 113, 114, respectively (see FIGS. 2A and 2B). When the fitting 100 is attached around the pipe 101, the ends 111, 112 of the first fitting half 105 are configured to abut the ends 113, 114 of the second fitting half 106. The first and second fitting halves 105, 106 are configured to be bonded together with an adhesive 115 (e.g., a high viscosity, non-sagging adhesive), described in detail below, applied to the adjoining ends 111, 112 and 113, 114. The first and second fitting halves 105, 106 are also configured to be bonded to the inner wall surface 104 of the sump 103 with the adhesive 115 to provide a fluid-tight seal between the first and second fitting halves 105, 106, and the sump wall 103.

Referring now to the embodiment illustrated in FIGS. 2A and 2B, the first and second fitting halves 105, 106 each include inner surfaces 116, 117, respectively, configured to abut the inner wall surface 104 of the sump wall 103 and outer surfaces 118, 119, respectively, opposite the inner surfaces 116, 117. In one embodiment, the inner surfaces 116, 117 of the fitting halves 105, 106 are generally flat. Together, the inner surfaces 116, 117 define an inner end 120 and the outer surfaces 118, 119 define an outer end 121.

In the illustrated embodiments, the inner and outer ends 120, 121, respectively, of the fitting halves 105, 106 are longitudinally spaced apart by a profile length L (i.e., the profile length L is the longitudinal envelope occupied by the fitting), as shown in FIG. 1C. In certain installations, a low profile penetration fitting 100 may be required to prevent interference between the fitting 100 and certain features of the pipe 101 or other components connected to the pipe 101 within the sump. For instance, in the embodiment illustrated in FIG. 1A in which the pipe 101 includes a substantially 90° elbow bend 122 inside the sump, the low profile L of the fitting halves 105, 106 is configured to prevent contact between the compression plate halves 109, 110, which are attached to the outer surfaces 118, 119 of the fitting halves 105, 106, and the pipe elbow 122. Otherwise, such contact may inhibit proper installation of the fitting 100 and may prematurely wear the pipe 101. In other embodiments, the low profile L of the fitting halves 105, 106 may prevent contact between the compression plate halves 109, 110 and another fitting on the pipe 101 (e.g., a termination fitting). In one embodiment, the profile length L may be between approximately 1 inch and approximately 2.5 inches, although the profile length L may be any other suitable dimension depending upon the configuration of the pipe and sump installation.

With continued reference to FIGS. 1B, 1C, 2A, and 2B, the first and second fitting halves 105, 106 each include an arcuate channel 123, 124, respectively, extending between the inner and outer surfaces 116, 117 and 118, 119, respectively. When the first and second fitting halves 105, 106 are attached together around the pipe 101, the arcuate channels 123, 124 cooperate to define an opening 125 configured to receive the elastically deformable sealing ring 107 through which the pipe 101 passes. As best shown in the cross-sectional profile illustrated in FIG. 1C, each arcuate channel 123, 124 includes a straight segment 126, 127 and a tapered segment 128, 129. The straight segments 126, 127 extend rearward from the inner surfaces 116, 117 of the fitting halves 105, 106, respectively. The tapered segments 128, 129 of the arcuate channels 123, 124 extend between an outer end 130, 131 of the straight segments 126, 127 and the outer surfaces 118, 119 of the fitting halves 105, 106, respectively. The tapered segments 128, 129 of the arcuate channels 123, 124 taper at an angle α between relatively narrower inner ends 132, 133 and relatively wider outer ends 134, 135 at the intersection with the outer surfaces 118, 119 of the fitting halves 105, 106. As shown in FIG. 1C, the taper angle α is defined between an imaginary longitudinal axis 136 of the fitting halves 105, 106 and the tapered segments 128, 129 of the arcuate channels 123, 124. In the illustrated embodiment, the tapered segments 128, 129 of the arcuate channels 123, 124 taper at a 20° angle α relative to the imaginary longitudinal axis 136 of the fitting halves 105, 106. In alternate embodiments, the tapered segments 128, 129 of the arcuate channels 123, 124 may taper at an angle α between approximately 5° and approximately 50°.

When the fitting halves 105, 106 are attached together around the pipe 101, the straight segments 126, 127 of the arcuate channels 123, 124 cooperate to define a circular opening 137 having a diameter D₁. The tapered segments 128, 129 of the arcuate channels 123, 124 cooperate to define a frusto-conical opening 138 having a relatively smaller inner diameter D₂ and a relatively larger diameter D₃ at the outer surfaces 118, 119 of the fitting halves 105, 106. As shown in the cross-sectional profile illustrated in FIG. 1C, the diameter D₁ of the circular opening 137 defined by the straight segments 126, 127 is smaller than the smaller inner diameter D₂ of the frusto-conical 138 opening such that semi-annular steps 139, 140 are defined in the fitting halves 105, 106, respectively, between the straight segments 126, 127 and the tapered segments 128, 129 of the arcuate channels 123, 124. Together, the semi-annular steps 139, 140 define an annular lip 141 in the fitting halves 105, 106. In an alternate embodiment, the fitting halves 105, 106 may be provided without the annular lip 141 such that the tapered segments 128, 129 of the arcuate channels 123, 124 extend completely between the inner and outer surfaces 116, 117 and 118, 119, respectively.

The frusto-conical opening 138 defined by the tapered segments 128, 129 of the arcuate channels 123, 124 is configured to receive the elastically deformable sealing ring 107, as described in more detail below. Additionally, the frusto-conical opening 138 enables the fitting 101 to accommodate pipes 101 penetrating the sump wall 103 at an oblique angle β. As shown in FIG. 1D, the oblique angle β of the pipe 101 is defined between an imaginary longitudinal axis 142 of the pipe 101 and the imaginary longitudinal axis 136 of the fitting halves 105, 106. For instance, in the illustrated embodiment of FIG. 1D in which the tapered segments 128, 129 of the arcuate channels 123, 124 taper at a 20° angle α, the penetration fitting 100 is configured to accommodate pipes 101 penetrating the sump wall 103 at an oblique angle β up to and including 20°.

Table 1 below shows the relationship between the nominal outer diameter D_{P} of the pipe 101, the smaller inner diameter D₂ of the frusto-conical opening 138 and the larger outer diameter D₃ of the frusto-conical opening 138 at the outer end 121 of the fitting halves 105, 106 for various embodiments of the present invention.

TABLE 1

| Nominal Outer | | |
|---|---|---|
| Diameter D_{P} of the Pipe | Larger Diameter D₃ | Smaller Diameter D₂ |
| (inches) | (inches) | (inches) |
| 2.0 | 3.5 | 2.6 |
| 4.0 | 5.4 | 4.5 |
| 4.0 | 5.8 | 4.9 |
| 0.5 | 2.0 | 1.0 |
| 0.8 | 2.3 | 1.3 |
| 1.0 | 2.5 | 1.5 |
| 3.0 | 4.6 | 3.8 |

It will be appreciated, however, that the present invention is not limited to the specific diameters recited above in Table 1, and any suitable combination of small and large diameters D₂, D₃, respectively, may be selected based upon the size of the pipe 101 and the oblique angle β at which the pipe 101 passes through the aperture 102 in the sump wall 103.

With reference again to the embodiment illustrated in FIGS. 2A and 2B, the fitting halves 105, 106 each also include a semi-annular flange 143, 144, respectively, formed about a periphery of the straight segments 126, 127 of the arcuate channels 123, 124. When the fitting halves 105, 106 are attached together around the pipe 101, the semi-annular flanges 143, 144 cooperate to define an annular flange 145 on the inner end 120 having an outer diameter D_{F} (see FIG. 1C). As depicted in FIG. 1B, the annular flange 145 on the inner end 120 is configured to abut the inner wall surface 104 of the sump wall 103 and surround the aperture 102 in the sump wall 103. In the illustrated embodiment, the semi-annular flanges 143, 144 include inner surfaces 146, 147, respectively, which are co-planar with the inner surfaces 116, 117 of the fitting halves 105, 106.

The fitting halves 105, 106 each also include a plurality of apertures 148, 149 disposed circumferentially around the semi-annular flanges 143, 144 of the fitting halves 105, 106. In the illustrated embodiment, each fitting half 105, 106 includes four apertures 148, 149, although it will be appreciated that the fitting halves 105, 106 may be provided with any other suitable number of apertures 148, 149, such as between two and ten or more, and still fall within the scope and spirit of the present invention. In the illustrated embodiment, each aperture 148, 149 includes a narrower circular bore 150 extending completely through the semi-annular flanges 143, 144 and a relatively larger circular recess 151 concentric with the circular bore 150. The larger circular recess 151 extends rearward from the inner surfaces 116, 117 of the fitting halves 105, 106 and through a portion of the semi-annular flanges 143, 144. The apertures 148, 149 are configured to receive a plurality of fasteners 152 securing the compression plate 108 to the fitting halves 105, 106, as described in detail below. Additionally, the larger circular recesses 151 are configured to receive the head portions 153 of the fasteners 152 and the narrower circular bores 150 are configured to receive the threaded shank portions 154 of the fasteners 152. The apertures 148, 149 are configured to countersink the fasteners 152 such that no portion of the fasteners 152 protrudes beyond the inner surfaces 116, 117 of the fitting halves 105, 106. Otherwise, protruding fasteners 152 would contact the inner wall surface 104 of the sump wall 103, thereby preventing a proper seal between the inner surfaces 116, 117 of the fitting halves 105, 106 and the sump wall 103.

With continued reference to FIGS. 2A and 2B, the fitting halves 105, 106 each also include a semi-annular lip 155, 156 formed about a periphery of the relatively wider outer ends 134, 135 of the arcuate channels 123, 124 (i.e., the larger outer diameter D₃ of the frusto-conical opening 138). When the fitting halves 105, 106 are secured together around the pipe 101, the semi-annular lips 155, 156 cooperate to define an annular lip 157 on the outer end 121 having a diameter D_{L}. In the illustrated embodiment, the diameter D_{F} of the annular flange 145 is larger than the diameter D_{L} of the annular lip 157 such than an annular shoulder 158 is formed between the annular flange 145 and the annular lip 157.

In the illustrated embodiment of FIGS. 1A-1C, a band 159 (e.g., a standard hose clamp or zip tie) is provided. The band 159 is configured to circumferentially surround the semi-annular lips 155, 156 of the fitting halves 105, 106. In one embodiment, the annular band 159 is configured to abut the annular shoulder 158, which facilitates installation of the annular band 159 and prevents the annular band 159 from sliding longitudinally along the fitting halves 105, 106. The annular band 159 is configured to bias the first and second fitting halves 105, 106 together until the adhesive 115 cures (i.e., the annular band 159 secures the first and second fitting halves 105, 106 together until the adhesive 115 applied to the adjoining ends 111, 112 and 113, 114 of the fitting halves 105, 106 cures to form a permanent bond). In one embodiment, the annular band 159 may be removed after the adhesive 115 has cured. In another embodiment, the uncured adhesive 115 may provide sufficient adhesion between the fitting halves 105, 106 such that penetration fitting 100 may be provided without the annular band 159.

The fitting halves 105, 106 may be formed from any suitably rigid material having a relatively high chemical resistivity to hydrocarbons, such as a fiber reinforced plastic (FRP) composite material. In one embodiment, the fitting halves 105, 106 are formed from a FRP composite material having approximately 25% by volume fiberglass and approximately 75% by volume resin. The fitting halves 105, 106 may be manufactured by any suitable means, such as machining and/or molding. In one embodiment, the fitting is first cast as a single part and then cut into the first and second fitting halves 105, 106 by any suitable process. When the fitting is cut into the first and second fitting halves 105, 106, fibers from the FRP composite material are exposed. The exposed fibers facilitate bonding between the adjoining ends 111, 112 and 113, 114 fitting halves 105, 106 with the adhesive 115. The fitting halves 105, 106 may then be secured together, such as by clamping, and then the arcuate channels 123, 124 may be formed, such as by machining the fitting halves 105, 106. Additionally, the inner surfaces 116, 117 of the first and second fitting halves 105, 106 may be machined flat while the fitting halves 105, 106 are secured together.

With reference now to the embodiment illustrated in FIGS. 3A and 3B, the elastically deformable sealing ring 107 is configured to be received in the frusto-conical opening 138 defined by the fitting halves 105, 106. In the illustrated embodiment, the elastically deformable sealing ring 107 is frusto-conical and includes an inner end 160 having a smaller diameter D₄ and an outer end 161 having a larger diameter D₅. The smaller diameter D₄ of the elastically deformable sealing ring 107 is generally equal to the smaller inner diameter D₂ of the frusto-conical opening 138 and the larger diameter D₅ of the elastically deformable sealing ring 107 is generally equal to the larger outer diameter D₃ of the frusto-conical opening 138, as illustrated in FIG. 1C. The sealing ring 107 also includes a surface 162 which tapers between the inner and outer ends 160, 161. The tapered surface 162 of the elastically deformable sealing ring 107 generally matches the tapered segments 128, 129 of the arcuate channels 123, 124 in the fitting halves 105, 106. Additionally, the elastically deformable sealing ring 107 defines a generally circular opening 163 having a diameter D_{S} configured to receive the pipe 101. The opening 163 extends between the inner and outer ends 160, 161 of the sealing ring 107. The diameter D_{S} of the opening 163 in the elastically deformable sealing ring 107 is substantially equal to the outer diameter D_{P} of the pipe 101 (see FIG. 1C).

When the penetration fitting 100 is installed around the pipe 101, the elastically deformable sealing ring 107 is configured to accommodate elongation of the pipe 101 due to, for example, the absorption of hydrocarbons in the sump environment. The elastically deformable sealing ring 107 is configured to allow the pipe 101 to “slip” relative to the penetration fitting 100, thereby reducing the shear stresses on the pipe 101. Otherwise, fixing the penetration fitting 100 to the pipe 101 would impart shear stresses on the pipe 101 when the pipe 101 elongates (e.g., pipe growth due to the absorption of hydrocarbons), and such shear stresses may damage the pipe 101, particularly if the pipe 101 includes a thin-walled secondary jacket around the primary pipe. The elastically deformable sealing ring 107 is also configured to accommodate pipes 101 passing through the aperture 102 in the sump wall 103 at an oblique angle β relative to the sump wall 103. When the pipe 101 passes through the sump wall 103 and the penetration fitting 100 at an oblique angle β, as shown in FIG. 1D, the elastically deformable sealing ring 107 conforms to fill the gap between the pipe 101 and the tapered segments 128, 129 of the fitting halves 105, 106, thereby maintaining a fluid-tight seal around the pipe 101.

Additionally, the sealing ring 107 includes a longitudinal slit 164 extending between the inner and outer ends 160, 161, respectively, of the sealing ring 107. The slit 164 is configured to enable a user to circumferentially expand the sealing ring 107 and then wrap the sealing ring 107 around the pipe 101 such that the pipe 101 extends through the opening 163 defined by the sealing ring 107. Accordingly, the slit 164 enables the elastically deformable sealing ring 107 to be installed around an existing pipe 101 without the need to cut the pipe 101. In an alternate embodiment, the sealing ring 107 may include first and second sealing ring halves attachable together around the pipe 101. The elastically deformable sealing ring 107 may be made out of an elastomeric material, such as rubber having a hardness of between approximately 60 Shore A and approximately 70 Shore A. In one embodiment, the elastically deformable sealing ring 107 may be made out of a material having a high chemical resistivity to hydrocarbons. Examples include nitrile rubbers such as BUNA-N, and partially cross-linked, chlorinated olefin interpolymer rubbers such as ALCRYN®, a melt-processible rubber. ALCRYN® rubber is sold by E.I. du Pont de Nemours and Company.

With reference now to FIG. 4, the compression plate 108 is configured to press the elastically deformable sealing ring 107 into the frusto-conical opening 138 defined by the fitting halves 105, 106 (see FIG. 1C). In the illustrated embodiment, the compression plate 108 includes first and second compression plate halves 109, 110 attachable together around the pipe 101. Together, the compression plate halves 109, 110 define an annulus surrounding the pipe 101. Additionally, the compression plate halves 109, 110 each include an arcuate notch 165, 166, respectively, which cooperate to define an opening 167 having a diameter D_{C} through which the pipe 101 passes. In one embodiment, the diameter D_{C} of the opening 167 defined by the compression plate halves 109, 110 is sized between the outer diameter D_{P} of the pipe 101 and the larger diameter D₅ of the elastically deformable sealing ring 107. Each of the compression plate halves 109, 110 includes an outer surface 168, 169, respectively, and an inner surface 170, 171, respectively, configured to abut the outer surfaces 118, 119 of the fitting halves 105, 106 and the outer end 161 of the elastically deformable sealing ring 107. It will be appreciated that the diameter D_{C} of the opening 167 defined by the compression plate halves 109, 110 is smaller than the larger diameter D₅ of the elastically deformable sealing ring 107 such that the inner surfaces 170, 171 of the compression plate halves 109, 110 abut the outer end 161 of the elastically deformable sealing ring 107. In the illustrated embodiment, both the inner surfaces 170, 171 and the outer surfaces 168, 169 are generally flat, planar surfaces.

With continued reference to FIG. 4, the compression plate 108 also includes a plurality of apertures 172, 173 (e.g., holes) disposed circumferentially around the compression plate halves 109, 110. The apertures 172, 173 in the compression plate halves 109, 110 are configured to align with the apertures 148, 149 in the fitting halves 105, 106. The corresponding apertures 148, 149 and 172, 173 in the fitting halves 105, 106 and the compression plate halves 109, 110 are configured to receive the plurality of fasteners 152 coupling the compression plate halves 109, 110 to the fitting halves 105, 106, as described below. The compression plate 108 may be formed from any suitably rigid and durable material, such as steel. The compression plate 108 may be made by any suitable process, such as machining, molding, casting, or rapid prototyping using additive manufacturing.

To install the penetration fitting 100 to the pipe 101 and the sump wall 103, a layer of non-sagging adhesive 115 is applied to the adjoining ends 111, 112 and 113, 114 of the fitting halves 105, 106. When the fitting halves 105, 106 are brought together around the pipe 101, the adhesive 115 applied to the adjoining ends 111, 112 and 113, 114 of the fitting halves 105, 106 is configured to attach the fitting halves 105, 106 together. A plurality of fasteners 152 are inserted into the circumferentially disposed apertures 148, 149 in the fitting halves 105, 106 before abutting the inner surfaces 116, 117 of the fitting halves 105, 106 against the inner wall surface 104 of the sump wall 103. When the fasteners 152 are inserted into the apertures 148, 149, the heads 153 of the fasteners 152 are recessed in the circular recesses 151 and portions of the threaded shafts 154 of the fasteners 152 extend beyond the outer surfaces 118, 119 of the fitting halves 105, 106. A layer of non-sagging adhesive 115 is also applied to the inner surfaces 116, 117 of the fitting halves 105, 106, respectively, before abutting the inner surfaces 116, 117 of the fitting halves 105, 106 against the inner wall surface 104 of the sump wall 103. Optionally, after the fitting halves 105, 106 are brought together around the pipe 101, the annular band 159 is installed around the semi-annular lips 155, 156 to bias the first and second fitting halves 105, 106 together until the adhesive 115 cures to form a permanent bond. In one embodiment, the annular band 159 may be removed after the adhesive 115 has cured. In one embodiment, the uncured adhesive 115 may provide sufficient adhesion between the fitting halves 105, 106 such that the annular band 159 is not required to hold the fitting halves 105, 106 together while the adhesive 115 cures.

The elastically deformable sealing ring 107 may be installed by circumferentially spreading the sealing ring 107 about the slit 164 and wrapping the sealing ring 107 around the pipe 101. When the sealing ring 107 is wrapped around the pipe 101, the pipe 101 extends through the opening 163 defined by the sealing ring 107. The elastically deformable sealing ring 107 may then be slid along the pipe 101 and into the frusto-conical opening 138 defined by the fitting halves 105, 106.

The compression plate 108 may be installed by bringing the compression plate halves 109, 110 together around the pipe 101, aligning the circumferentially disposed apertures 172, 173 in the compression plates halves 109, 110 with the fasteners 152, and then sliding the compression plate halves 109, 110 toward the outer surfaces 118, 119 of the fitting halves 105, 106 and the outer end 161 of the elastically deformable sealing ring 107 until the threaded shafts 154 of the fasteners 152 extend through the apertures 172, 173 in the compression plate halves 109, 110. A plurality of nuts 174 and washers 175 may then be attached to the threaded shafts 154 of fasteners 152, as shown in FIG. 1C. When the nuts 174 are tightened, the inner surfaces 170, 171 of the compression plate halves 109, 110 are drawn into abutment with the outer surfaces 118, 119 of the fitting halves 105, 106 and the outer end 161 of the elastically deformable sealing ring 107. The abutment between the compression plate halves 109, 110 and the outer end 161 of the elastically deformable sealing ring 107 presses the elastically deformable sealing ring 107 into the frusto-conical opening 138 defined by the fitting halves 105, 106.

When the elastically deformable sealing ring 107 is pressed into the frusto-conical opening 138 by the compression plate 108, the inner end 160 of the sealing ring 107 is configured to abut the annular lip 141 in the fitting halves 105, 106. Additionally, when the sealing ring 107 is pressed by the compression plate 108, the outer end 161 of the elastically deformable sealing ring 107 is generally co-planar with the outer surfaces 118, 119 of the fitting halves 105, 106. Accordingly, the annular lip 141 and the compression plate 108 are configured to retain the elastically deformable sealing ring 107 in the frusto-conical opening 138 defined by the fitting halves 105, 106. Moreover, when the elastically deformable sealing ring 107 is pressed into the frusto-conical opening 138 by the compression plate 108, the tapered segments 128, 129 of the fitting halves 105, 106 are configured to circumferentially press the elastically deformable sealing ring 107 against the pipe 101, thereby creating a liquid-tight seal around the pipe 101. Together, the adhesive 115 applied to the adjoining ends 111, 112 and 113, 114 and the inner surfaces 116, 117 of the fitting halves 105, 106 and the elastically deformable sealing ring 107 in the frusto-conical opening 138 create a liquid-tight seal between the pipe 101 and the aperture 102 in the sump wall 103.

Referring now to the embodiment illustrated in FIGS. 5A-5C, an adapter plate 180 can be provided to accommodate sumps having a curved wall 181 (e.g., round or cylindrical-walled sumps). The adapter plate 180 is disposed between an inner wall surface 182 of the sump wall 181 and the inner surfaces 116, 117 of the fitting halves 105, 106. In the illustrated embodiment, the adapter plate 180 includes a first half 183 and a second half 184 attachable together around the pipe 101. Together, the first and second adapter plate halves 183, 184, respectively, define an annulus surrounding the pipe 101. The first and second adapter plate halves 183, 184 each include an inner surface 185, 186 configured to abut the inner wall surface 182 of the sump wall 181 and outer surface 187, 188 configured to abut the inner surfaces 116, 117 of the fitting halves 105, 106. In the illustrated embodiment, the inner surfaces 185, 186 of the adapter plate 180 are curved to generally match the curvature of the inner wall surface 182 of the sump wall 181 and the outer surfaces 187, 188 of the adapter plate 180 are generally flat to match the generally flat inner surfaces 116, 117 of the fitting halves 105, 106. In an alternate embodiment, the penetration fitting 100 may be provided without the adapter plate 180 and a relatively thick layer of adhesive may be provided between the curved inner surface 182 sump wall 181 and the inner surfaces 185, 186 of the fitting halves 105, 106 to ensure proper sealing between the fitting halves 105, 106 and the curved sump wall 181 (i.e., a layer of adhesive may fill the gap between the curved inner wall surface 182 of the sump wall 181 and the flat inner surfaces 116, 117 of the fitting halves 105, 106).

With continued reference to FIGS. 5A-5C, the adapter plate halves 183, 184 define an opening 190 having a diameter D_{A}. The opening 190 extends between the inner surfaces 185, 186 and the outer surfaces 187, 188 of the adapter plates halves 183, 184. In the illustrated embodiment, the opening 190 is generally circular in transverse cross-section, although the opening 190 may have any other suitable cross-sectional shape and still fall within the scope and spirit of the present invention. In the illustrated embodiment, the diameter D_{A} of the opening 190 defined by the adapter plate halves 183, 184 is generally equal to the diameter D₁ of the circular opening 137 defined by the straight segments 126, 127 of the arcuate channels 123, 124 in the fitting halves 105, 106.

To install the adapter plate 180, adhesive 115 is first applied to both the inner surfaces 185, 186 and the outer surfaces 187, 188 of the adapter plate halves 183, 184. The adapter plate halves 183, 184 are then attached together around the pipe 101, and the inner surfaces 185, 186 are abutted against the inner wall surface 182 of the curved sump wall 181. After the adapter plate 180 is installed, the penetration fitting 100 may be installed substantially as described above. However, instead of abutting the inner surfaces 116, 117 of the fitting halves 105, 106 against the inner wall surface 182 of the sump wall 181, the inner surfaces 116, 117 of the fitting halves 105, 106 are abutted against the outer surfaces 187, 188 of the adapter plate halves 183, 184.

With reference now to the embodiment illustrated in FIGS. 6A-6E, some conventional sump walls are formed of a flexible material (e.g., polyethylene) and therefore tend to warp under external loading. The localized warping of a sump wall 191 may compromise the integrity and efficacy of the seal formed between the pipe 192 and the aperture 193 (e.g., hole) in the sump wall 191 by the penetration fitting 100. In such a situation, a hub 194 can be provided to mechanically secure the penetration fitting 100 to the sump wall 191 to create a liquid-tight seal around the pipe 192 penetrating the aperture 193 in the sump wall 191. The hub 194 is configured to maintain localized flattening of the sump wall 191 in the region of the sump wall 191 to which the penetration fitting 100 is attached (i.e., the hub 194 is configured to locally flatten the sump wall 191 around the aperture 193 in the sump wall 191 by mechanically drawing the sump wall 191 flush against the hub 194). Additionally, adhesives configured to bond to polyethylene tend to swell and delaminate in a fuel environment. Accordingly, the hub 194 is configured to mechanically compress the adhesive sealing the hub 194 to the sump wall 191, and thereby prevent delamination of the adhesive from the sump wall 191. In one embodiment, the hub 194 is also configured to create a vapor barrier between the adhesive and any fuel vapor that may be present inside the sump.

In the embodiment illustrated in FIGS. 6A and 6C, the hub 194 is disposed between an inner wall surface 195 of the sump wall 191 and the inner surfaces 116, 117 of the fitting halves 105, 106. Additionally, in certain sump installations, an existing boot 196 may have already been installed on an outer wall surface 197 of the sump wall 191 with a plurality of fasteners 198 extending through the sump wall 191, as shown in the embodiment illustrated in FIG. 6B. When an existing boot 196 is installed to an outer wall surface 197 of the sump wall 191, the hub 194 can be installed to the inner wall surface 195 of the sump wall 191 using the same fasteners 198 that secured the existing boot 196 to the sump wall 191 (i.e., the existing fasteners 198 can be repurposed to secure the hub 194 to the sump wall 191).

As illustrated in the embodiment of FIG. 6C, the boot 196 and the sump wall 191 both include a circular pattern of openings 199, 200, respectively. The circular pattern of openings 199 in the boot 196 is aligned with the circular pattern of openings 200 in the sump wall 191 to receive the fasteners 198 securing the boot 196 to the sump wall 191. Accordingly, to facilitate installation of the hub 194 with the existing fasteners 198, the hub 194 includes a plurality of circumferentially disposed apertures 201, described in more detail below, configured to align with the circular pattern of openings 199, 200 in the boot 196 and the sump wall 191, respectively.

With reference now to FIGS. 6C-6E, the hub 194 includes first and second hub halves 202, 203 configured to be attached together around the pipe 192. The first and second hub halves 202, 203 are configured to enable the hub 194 to be installed around existing pipes without having to cut the pipe 192. The hub halves 202, 203 each include an inner surface 204, 205 configured to abut the inner wall surface 195 of the sump wall 191 and an outer surface 206, 207 configured to abut the inner surfaces 116, 117 of the fitting halves 105, 106, respectively. The hub halves 202, 203 include first and second semi-annular rims 208, 209 (best shown in FIGS. 6D and 6E). Together, the first and second semi-annular rims 208, 209 cooperate to define an opening 210 configured to receive the pipe 192. The first and second semi-annular rims 208, 209 also cooperate to define an annular rim completely surrounding the pipe 192. The first and second semi-annular rims 208, 209 also include the plurality of apertures 201 configured to receive the plurality of fasteners 198 securing the hub 194 to the sump wall 191, as described in further detail below.

With continued reference to the embodiment illustrated in FIGS. 6A and 6C-6E, the first and second hub halves 202, 203 also include first and second semi-annular standoffs 211, 212, respectively, extending circumferentially around outer peripheries of the semi-annular rims 208, 209 and projecting rearward. Together, the semi-annular standoffs 211, 212 are configured to space the fitting halves 105, 106 apart from the semi-annular rims 208, 209 such that the fasteners 198 securing the hub 194 to the sump wall 191 do not contact the fitting halves 105, 106. As shown in FIGS. 6C and 6E, the semi-annular rims 208, 209 are wider than the semi-annular standoffs 211, 212 such that an annular shoulder 213 is defined between the semi-annular rims 208, 209 and the semi-annular standoffs 211, 212. Moreover, a cavity 214 is defined between the shoulder 213 of the hub 194 and the inner surfaces 116, 117 of the fitting halves 105, 106. The cavity 214 is configured to house a portion of the fasteners 198 securing the hub 194 to the sump wall 191.

In the illustrated embodiment of FIGS. 6C and 6D, both of the hub halves 202, 203 also include a pair of spaced apart arcuate ridges 215, 216 projecting outward from the inner surfaces 204, 205, the significance of which is explained below. In an alternate embodiment in which the sump wall is formed from a generally rigid material, such as fiber-reinforced plastic (FRP), the hub 194 may be provided without the ridges 215, 216.

To install the hub 194, a boot on the inside of the sump (not shown) is first detached from the fasteners 198 by unscrewing nuts 217 on the ends of the fasteners 198. A layer of adhesive 115 may then be applied to the inner surfaces 204, 205 between the arcuate ridges 215, 216 of the hub halves 202, 203, respectively. The hub 194 is then installed by aligning the circumferentially disposed apertures 201 in the hub 194 with the fasteners 198 and then drawing the hub 194 against the inner wall surface 195 of the sump wall 191 such that the threaded shafts 218 of the fasteners 198 extend through the apertures 201 in the hub 194. The nuts 217 are then reinstalled on the ends of the fasteners 198. As the nuts 217 are tightened, the region of the sump wall 191 around the aperture 193 is drawn flush against the inner surfaces 204, 205 of the hub halves 202, 203. In an alternate embodiment in which an existing boot 196 is not installed to the outer wall surface 197 of the sump wall 191 with a plurality of fasteners 198, the hub 194 may be installed to the inner wall surface 195 of the sump wall 191 with a plurality of blind fasteners.

When the hub 194 is attached to the sump wall 191, the narrow arcuate ridges 215, 216 are configured to dig into the inner wall surface 195 of the sump wall 191, as shown in FIG. 6C. The engagement between the narrow arcuate ridges 215, 216 and the inner wall surface 195 of the sump wall 191 is configured to create a fluid-tight seal between the inner surfaces 204, 205 of the hub halves 202, 203 and the inner wall surface 195 of the sump wall 191. Additionally, when adhesive 115 is applied to the inner surfaces 204, 205 of the hub halves 202, 203, the narrow arcuate ridges 215, 216 encapsulate the adhesive 115 between the ridges 215, 216 and isolate it from any fuel vapor that may be present inside the sump. Otherwise, exposing the adhesive 115 to the fuel vapor inside the sump may cause the adhesive to 115 to swell and delaminate from the inner wall surface 195 of the sump wall 191, thereby compromising the integrity and efficacy of the seal formed around the aperture 193 in the sump wall 191. After the hub 194 is installed to the sump wall 191, the penetration fitting 100 may be installed substantially as described above. However, instead of abutting the inner surfaces 116, 117 of the fitting halves 105, 106 against the inner wall surface 195 of the sump wall 191, the inner surfaces 116, 117 of the fitting halves 105, 106 are abutted against the outer surfaces 206, 207 of the semi-annular standoffs 211, 212 of the hub 194. Additionally, a fluid-tight seal may be formed between the fitting 100 and the hub 194 by applying an annular bead of adhesive 115 extending around a joint between the inner surfaces 116, 117 of the fitting halves 105, 106 and the semi-annular standoffs 211, 212 of the hub 194.

The adhesive 115 can be made of any suitable resin composite configured to bond to fiberglass. In one embodiment, the adhesive 115 is a composite of an epoxy-based resin and fumed silica filler or fiberglass filler. In other embodiments, the adhesive 115 may be a composite of a vinylester- or polyester-based resin and fumed silica filler or fiberglass filler. In one embodiment, the adhesive 115 is a non-sagging adhesive compound having a viscosity between approximately 2,000 centipoise (cps) and 10,000,000 cps. Using a non-sagging adhesive 115 having a viscosity between approximately 2,000 cps and 10,000,000 cps helps to prevent the adhesive 115 from running during installation.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims. Although relative terms such as “outer,” “inner,” “upper,” “lower,” “below,” “above,” and similar terms have been used herein to describe a spatial relationship of one element to another, it is understood that these terms are intended to encompass different orientations of the various elements and components of the device in addition to the orientation depicted in the figures. Although the penetration fitting of the present invention is shown and described in use with a sump, the penetration fitting is not limited to such applications, and the penetration fitting of the present invention may be used in any industry to provide a fluid-tight seal around longitudinal members (e.g., tubes, pipes, conduits, etc.) penetrating through a wall segment. Additionally, although the present invention has been described with reference to fluid-carrying pipes, the penetration fitting described herein may also be used for non-fluid-carrying pipes, such as electrical conduits. Furthermore, although the fitting of the present invention has been described with reference to first and second halves, other variations are possible, such as fittings having more than two parts or fittings having parts of different sizes.

What is claimed is:

1. A penetration fitting configured to form a seal between at least one flexible pipe segment and a sump wall at an aperture in the sump wall through which the at least one pipe segment passes, the penetration fitting comprising:
a first fitting half having an inner surface and an outer surface opposite the inner surface, the first fitting half defining a first arcuate channel having a wider end and a narrower end;
a second fitting half having an inner surface and an outer surface opposite the inner surface, the second fitting half defining a second arcuate channel having a wider end and a narrower end, wherein the first and second fitting halves are configured to abut one another with the inner surfaces of the first and second fitting halves together defining an inner end, the outer surfaces of the first and second fitting halves together defining an outer end, and the arcuate channels of the first and second fitting halves together defining a tapered opening, the tapered opening having a smaller diameter at the inner end and a larger diameter at the outer end with the inner end configured to be sealed to the sump wall around the aperture;
an elastically deformable sealing ring configured to be received in the tapered opening, the sealing ring having an inner end and an outer end opposite the inner end, the sealing ring defining an opening configured to accept the at least one pipe segment; and
a compression plate configured to retain the elastically deformable sealing ring in the tapered opening, the compression plate having an inner surface configured to abut the outer end of the first and second fitting halves and the outer end of the sealing ring.

2. The penetration fitting of claim 1, further comprising:
an annular lip defined by the first and second arcuate channels, wherein the inner end of the sealing ring is configured to abut the annular lip to retain the sealing ring in the tapered opening.

3. The penetration fitting of claim 1, wherein the first fitting half includes a semi-annular first flange formed about a periphery of the narrower end of the first arcuate channel, and the second fitting half includes a semi-annular second flange formed about a periphery of the narrower end of the second arcuate channel, the first and second semi-annular flanges cooperating to define an annular flange on the inner end of the fitting configured to surround the aperture in the sump wall.

4. The penetration fitting of claim 3, wherein the first fitting portion includes a semi-annular first lip formed about a periphery of the wider end of the first arcuate channel, and the second fitting portion includes a semi-annular second lip formed about a periphery of the wider end of the second arcuate channel, the first and second semi-annular lips cooperating to define an annular lip on the outer end of the fitting.

5. The penetration fitting of claim 4, further comprising:
an annular shoulder defined between the annular flange and the annular lip; and
an annular band configured to surround the annular lip to bias the first and second fitting halves together at the shoulder.

6. The penetration fitting of claim 1, further comprising an adhesive layer disposed between an inner wall surface of the sump wall and the inner end of the fitting halves.

7. The penetration fitting of claim 6, wherein the adhesive comprises resin and filler, and wherein the filler is selected from the group consisting of fumed silica and fiberglass.

8. The penetration fitting of claim 6, wherein the adhesive comprises a material having a viscosity between approximately 2,000 centipoise (cps) and 10,000,000 cps.

9. The penetration fitting of claim 1, wherein the elastically deformable sealing ring includes a slit extending between the inner and outer surfaces of the sealing ring, the slit configured to enable the sealing ring to circumferentially expand to receive the at least one pipe segment.

10. The penetration fitting of claim 1, wherein the sealing ring comprises a first sealing ring half and a second sealing ring half, the first and second sealing ring halves being attachable together around the at least one flexible pipe.

11. The penetration fitting of claim 1, wherein the first and second fitting halves further comprise a plurality of circumferentially disposed openings and the compression plate further comprises a plurality of circumferentially disposed openings configured to align with the openings in the first and second fitting halves, the openings in the fitting halves and the compression plate configured to receive a plurality of fasteners coupling the compression plate to the first and second fitting halves.

12. The penetration fitting of claim 1, wherein:
the tapered opening in the penetration fitting is generally frusto-conical; and
the sealing ring is generally frusto-conical.

13. The penetration fitting of claim 1, wherein the first and second fitting halves comprise fiberglass reinforced plastic (FRP).

14. The penetration fitting of claim 1, wherein the sealing ring comprises rubber having a hardness between approximately 60 Shore A and approximately 70 Shore A.

15. The penetration fitting of claim 1, wherein the first and second fitting halves are generally rigid.

16. The penetration fitting of claim 1, wherein the arcuate channels taper at an angle between approximately 5 degrees and approximately 50 degrees.

17. The penetration fitting of claim 1, wherein the inner and outer ends of the fitting halves are spaced apart by a distance between approximately 1 inch and approximately 2.5 inches.

18. The penetration fitting of claim 1, further comprising an adapter plate configured to accommodate a sump wall with a curved inner wall surface, the adapter plate comprising:
an annulus having opposing inner and outer surfaces; and
an opening extending between the inner and outer surfaces,
wherein the inner surface is curved and the outer surface is substantially flat, and
wherein the inner surface is configured to abut the curved inner wall surface of the sump wall, and the outer surface is configured to abut the inner end of the fitting halves, thereby permitting the inner end of the first and second fitting halves to be sealed to the sump wall via the adapter plate.

19. The penetration fitting of claim 18, further comprising an adhesive layer disposed between the outer surface of the adapter plate and the inner end of the fitting halves.

20. The penetration fitting of claim 18, wherein the adapter plate comprises a first adapter plate half and a second adapter plate half, the first and second adapter plate halves being attachable together around the at least one pipe.

21. The fitting of claim 1, further comprising a hub configured to mechanically secure the penetration fitting to the sump wall and draw the sump wall flush against the hub, the hub comprising:
a first semi-annular rim;
a second semi-annular rim attachable to the first semi-annular rim, the first and second semi-annular rims cooperating to define an opening; and
a plurality of apertures disposed circumferentially around the rims, the plurality of apertures configured to receive a plurality of fasteners securing the hub to the sump wall, wherein the hub includes opposing inner and outer surfaces, the inner surface configured to abut an inner wall surface of the sump wall, and the outer surface configured to abut the inner end of the fitting halves, thereby permitting the inner end of the first and second fitting halves to be sealed to the sump wall via the hub.

22. The penetration fitting of claim 21, wherein the first semi-annular rim further comprises a first semi-annular standoff extending around a periphery of the first semi-annular rim, and the second semi-annular rim further comprises a second semi-annular standoff extending around a periphery of the second semi-annular rim, the standoffs having outer surfaces configured to abut the inner end of the fitting halves.

23. The penetration fitting of claim 22, further comprising an adhesive bead extending along a joint between the semi-annular standoffs and the inner end of the fitting halves.

24. The penetration fitting of claim 21, wherein the first and second semi-annular rims each include at least one narrow ridge projecting from the inner surface and configured to penetrate into the inner wall surface of the sump wall.

25. A penetration fitting assembly configured to form a seal between at least one flexible pipe segment and a sump wall with a curved inner wall surface at an aperture in the sump wall through which the at least one flexible pipe segment passes, the penetration fitting assembly comprising:
a penetration fitting comprising:
a first fitting half having an inner surface and an outer surface opposite the inner surface, the first fitting half defining an arcuate channel; and
a second fitting half having an inner surface and an outer surface opposite the inner surface, the second fitting half defining an arcuate channel, wherein the first and second fitting halves are adapted to abut one another with the inner surfaces of the first and second fitting halves together defining an inner end, the outer surfaces of the first and second fitting halves defining an outer end, and the arcuate channels of the first and second fitting halves cooperating to define a tapered opening, the opening having a smaller diameter at the inner end and a larger diameter at the outer end;
a fructo-conical elastically deformable sealing ring configured to be received in the tapered opening, the sealing ring defining an opening configured to accept the at least one pipe segment; and
a compression plate configured to retain the sealing ring in the tapered opening, the compression plate having an inner surface configured to abut the outer end of the first and second fitting halves and the outer surface of the sealing ring; and
an adapter plate comprising:
an annulus having opposing inner and outer surfaces; and
an opening extending between the inner and outer surfaces, wherein the inner surface is curved and the outer surface is substantially flat, and wherein the inner surface is configured to abut the curved inner wall surface of the sump wall, and the outer surface is configured to abut the inner end of the fitting halves, thereby permitting the inner end of the first and second fitting halves to be sealed to the sump wall via the adapter plate.

26. A penetration fitting assembly configured to form a seal between at least one pipe segment and a sump wall at an aperture in the sump wall through which the at least one pipe segment passes, the penetration fitting assembly comprising:
a penetration fitting comprising:
a first fitting half having an inner surface and an outer surface opposite the inner surface, the first fitting half defining an arcuate channel; and
a second fitting half having an inner surface and an outer surface opposite the inner surface, the second fitting half defining an arcuate channel, wherein the first and second fitting halves are adapted to abut one another with the inner surfaces of the first and second fitting halves together defining an inner end, the outer surfaces of the first and second fitting halves defining an outer end, and the arcuate channels of the first and second fitting halves cooperating to define a tapered opening, the opening having a smaller diameter at the inner end and a larger diameter at the outer end;
a fructo-conical elastically deformable sealing ring configured to be received in the tapered opening, the sealing ring defining an opening configured to accept the at least one pipe segment; and
a compression plate configured to retain the elastically deformable sealing ring in the tapered opening, the compression plate having an inner surface configured to abut the outer end of the first and second fitting halves and the outer surface of the sealing ring; and
a hub configured to mechanically secure the penetration fitting to the sump wall and draw the sump wall flush against the hub, the hub comprising:
a first semi-annular rim;
a second semi-annular rim attachable to the first semi-annular rim, the first and second semi-annular rims cooperating to define an opening; and
a plurality of apertures disposed circumferentially around the rims, the plurality of apertures configured to receive a plurality of fasteners securing the hub to the sump wall, wherein the hub includes opposing inner and outer surfaces, the inner surface configured to abut an inner wall surface of the sump wall, and the outer surface configured to abut the inner end of the fitting halves, thereby permitting the inner end of the first and second fitting halves to be sealed to the sump wall via the hub.
